(19) United States
(12) Patent Application Publication
(10) Pub. No.: US 2005/0143491 A1
(43) Pub. Date: Jun. 30, 2005

(54) Ink composition for ink jet recording, manufacturing method of the same, and ink jet recording method

(75) Inventor: Keitaro Aoshima, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM., LTD.

(21) Appl. No.: 11/005,008

(22) Filed: Dec. 7, 2004

(30) Foreign Application Priority Data
Dec. 26, 2003 (JP) P. 2003-434232

(51) Int. Cl. C09D 11/00; C03C 17/00

(52) U.S. Cl. 523/160; 523/161

(57) ABSTRACT

An ink composition for ink jet recording comprises: a dispersion medium; and charged particles containing a coloring material, wherein the charged particles are dispersed in the dispersion medium by a dispersant containing a block polymer, and a manufacturing method of the same and an ink jet recording method also are provided.

### BACKGROUND OF THE INVENTION

1. Field of the Invention

The present invention relates to an ink composition for ink jet recording, a manufacturing method of the same, and an ink jet recording method.

2. Background Art

As image recording methods of forming an image on a medium to be recorded, e.g., paper, on the basis of image data signals, an electrophotographic system, a sublimation type and a melting type heat transfer system, and an ink jet system are used. An electrophotographic system requires a process of forming an electrostatic latent image on a photosensitive drum by charge and exposure, so that the system is complicated and the apparatus is expensive. The price of the apparatus is inexpensive as for a heat transfer system, but the system uses ink ribbons, so that it is high in running cost and leaves wastes. On the other hand, in an ink jet system, since the apparatus is inexpensive and furthermore an image is directly formed on a medium to be recorded by jetting inks only on a required image part, ink can be efficiently used, so that running cost is low. Further, an ink jet system is low in noise and excellent as an image recording system.

Ink jet recording systems include, for example, a system of jetting ink droplets by the pressure of vapor generated by the heat of a heating unit, a system of jetting ink droplets by the mechanical pressure pulse generated by piezoelectric elements, and a system of jetting ink droplets by containing charged particles by utilizing electrostatic field (patent literature 1, U.S. Pat. No. 6,158,844). Methods of jetting ink droplets by vapor or mechanical pressure cannot control the flying direction of ink droplets and it is difficult to correctly land ink droplets on a desired point on a medium to be recorded by distortion of ink nozzles and convection of air.

On the other hand, since a method of using electrostatic field controls the flying direction of ink droplets by electrostatic field, it is possible to correctly land ink droplets on a desired point, and image-formed matters (printed matters) of high quality can be made and an excellent method.

As the ink composition to be used in ink jet recording using electrostatic field, an ink composition comprising a dispersion medium and charged particles containing at least coloring materials (patent literature 2, U.S. Pat. No. 5,952,048) is used. An ink composition containing coloring materials can form inks of four colors of yellow, magenta, cyan and black by changing coloring materials, and further special color inks of gold and silver can be formed. Accordingly, this system is useful as color image-formed matters (printed matters) can be produced. However, in long term ink jet recording, it was difficult to jet ink droplets stably at all times.

### SUMMARY OF THE INVENTION

The present invention has been done aiming at jetting ink droplets stably at all times in long term ink jet recording. Accordingly, the objects of the present invention are to provide an ink composition for ink jet recording, which makes it possible to form high quality images for a long period of time, to provide a manufacturing method of the same, and to provide an ink jet recording method.

As a result of eager investigation to achieve the above objects, the present inventor has found that the jetting characteristics of ink droplets greatly depend upon the dispersion stability of the particles containing coloring materials which are contained in the ink to be used, and the characteristics are improved by using a specific dispersant, thus the present invention has been achieved.

That is, the present invention is as follows.

(1) An ink composition for ink jet recording, comprising: a dispersion medium; and charged particles containing a coloring material, wherein the charged particles are dispersed in the dispersion medium by a dispersant containing a block polymer.

(2) The ink composition for ink jet recording as claimed in the item (1), wherein the block polymer comprises a polymer segment insoluble in the dispersion medium and a polymer segment soluble in the dispersion medium.

(3) The ink composition for ink jet recording as claimed in the item (1) or (2), wherein the dispersion medium is a dielectric liquid having a electrical resistivity of 10¹⁰ Ωcm or higher.

(4) The ink composition for ink jet recording as claimed in anyone of the items (1) to (3), wherein the coloring material is dispersed in a dispersion medium in the state of being covered with a covering material.

5. The ink composition for ink jet recording as claimed in any one of the items (1) to (4), wherein the block polymer is represented by the following formula (5):
-[A]-b-[B] (5)
wherein A represents a polymer segment insoluble in a dispersion medium; B represents a polymer segment soluble in a dispersion medium; b shows that the Segment A and segment B are block-bonded.

(6) The ink composition for ink jet recording as claimed in any one of the items (1) to (5), wherein the block polymer is a polymer containing a polymer segment containing a constitutional unit represented by the following formula (6) and a polymer segment containing a constitutional unit represented by the following formula (7): 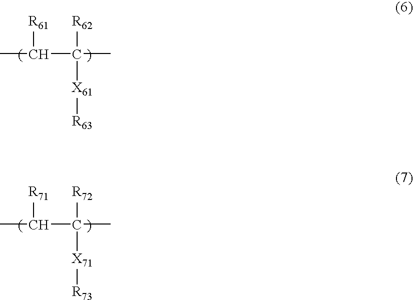
wherein R₆₁, R₆₂, R₇₁ and R₇₂, which may be the same or different, each represents a hydrogen atom or a methyl group;
R₆₃ represents a hydrogen atom or a hydrocarbon group having from 1 to 20 carbon atoms which may have a substituent, wherein a silicon atom, an ether bond, an ester bond, an amido bond, a carbamate bond, a halogen group, a hydroxyl group, an amino group, an ammonium group, a carboxyl group, a sulfonic acid group, a phosphoric acid group, or a phosphonic acid group may be contained in the hydrocarbon group;
R₇₃ represents a hydrocarbon group having from 2 to 40 carbon atoms which may have a substituent, wherein a silicon atom, an ether bond, an ester bond, an amido bond, a carbamate bond, or a halogen group may be contained in the hydrocarbon group;
X₆₁ and X₇₁, which may be the same or different, each represents a single bond, or a divalent linking group having total carbon atoms of 50 or less, which comprises two or more atoms selected from C, H, N, O, S and P.

(7) The ink composition for ink jet recording as claimed in any one of the items (1) to (6), wherein the block polymer has a weight average molecular weight of 1,000 or more.

(8) The ink composition for ink jet recording as claimed in any one of the items (1) to (7), which satisfies at least one of the following conditions:
(A) The volume average diameter of the charged particles is in the range of from 0.20 to 5.0 μm;
(B) The concentration of the solids content of the ink composition is in the range of from 1 to 60 mass %;
(C) The electric conductivity of the ink composition at 20° C. is from 10 to 100,000 pS/cm; and
(D) The viscosity of the ink composition at 20° C. is from 0.5 to 50 mPa.s.

(9) A manufacturing method of an ink composition for ink jet recording, the ink composition comprising: a dispersion medium; and charged particles containing a coloring material, in which the method comprises dispersing the charged particles in the dispersion medium by a dispersant containing a block polymer.

(10) An ink jet recording method comprising jetting an ink composition by utilizing electrostatic field, wherein the ink composition comprises a dispersion medium and charged particles containing a coloring material, and the charged particles are dispersed in the dispersion medium by a dispersant containing a block polymer.

The present invention can provide an ink composition for ink jet recording capable of jetting ink droplets stably at all times in long term ink jet recording, free from ink jet failure, capable of forming high quality images free from streaks and blotting, and good in an anti-blocking property, e.g., image-recorded matters are not adhered to each other with the lapse of time even when recorded matters are piled; a manufacturing method of the same; and an ink jet recording method.

### BRIEF DESCRIPTION OF THE DRAWINGS

FIG. 1 is a general view typically showing an example of ink jet recording apparatus for use in the present invention.

FIG. 2 is an oblique view showing the constitution of the ink jet head of ink jet recording apparatus for use in the present invention (for simplification, the edge of the guard electrode at each jetting part is not shown).

FIG. 3 is a cross section of side view of FIG. 2 showing the state of the distribution of charged particles in the case where a plurality of jetting parts of ink jet head are used (corresponding to the view X-X in FIG. 2).

### DESCRIPTION OF REFERENCE NUMERALS AND SIGNS

G: Jetted ink droplets

P: Recording medium

Q: Ink flow

R: Charged particles

1: Ink jet recording apparatus

2: Jet head

3: Ink circulating system

4: Head driver

5: Position controlling means

6A to 6C: Carrier belt stretching rollers

7: Carrier belt

8: Carrier belt position detecting means

9: Electrostatic suction means

10: Destaticizing means

11: Mechanical means

12: Feed roller

13: Guide

14: Image fixing means

15: Guide

16: Recording medium position-detecting means

17: Exhaust fan

18: Solvent vapor adsorbing material

38: Ink guide

40: Supporting bar

42: Ink meniscus

44: Insulating layer

46: First jet electrode

48: Insulating layer

50: Guard electrode

52: Insulating layer

56: Second jet electrode

58: Insulating layer

62: Floating conductive plate 62

64: Covering film

66: Insulating member

70: Ink jet head

72: Ink channel

74: Substrate

75, 75A, 75B: Openings

76, 76A, 76B: Jetting parts

78: Jetting part

### DETAILED DESCRIPTION OF THE INVENTION

The present invention is described in further detail below.

The ink composition according to the invention contains a dispersion medium and charged particles containing at least coloring materials.

Dispersion Medium:

A dispersion medium is preferably a dielectric liquid having high electrical resistivity, specifically 10¹⁰ Ωcm or higher. If a dispersion medium having low electrical resistivity is used, electrical continuity occurs between contiguous recording electrodes, so that such a dispersion medium is not preferred for the present invention. The dielectric constant of a dielectric liquid is preferably 5 or less, more preferably 4 or less, and still more preferably 3.5 or less. By this range of the dielectric constant, electric field effectively acts upon the charged particles in a dielectric liquid and preferred.

As the dispersion media for use in the invention, straight chain or branched aliphatic hydrocarbon, alicyclic hydrocarbon, aromatic hydrocarbon, halogen substitution products of these hydrocarbons, and silicone oil are exemplified. For example, hexane, heptane, octane, isooctane, decane, isodecane, decalin, nonane, dodecane, isododecane, cyclohexane, cyclooctane, cyclodecane, toluene, xylene and mesitylene are exemplified, specifically Isopar-C, Isopar-E Isopar-G, Isopar-H, Isopar-L and Isopar-M (Isopar is the trade name of Exxon), Shellsol 70 and Shellsol 71 (Shellsol is the trade name of Shell Oil Co.), Amsco OMS and Amsco 460 solvents (Amsco is the trade name of Spirits Co.), and KF-96L (trade name, manufactured by Shin-Etsu Chemical Co., Ltd., Silicone Division) can be used alone or as a mixture. The amount of dispersion medium in all the ink composition is preferably from 20 to 99 mass %. When the amount of a dispersion medium is 20 mass % or more, particles containing coloring materials can be dispersed in the dispersion medium, and 99 mass % or less can suffice the amount of coloring material.

Coloring Material:

Well-known dyes and pigments can be used as the coloring materials in the invention, and they can be selected according to the use and the purpose. For example, from the viewpoint of the tone of image-recorded matters (printed matters), it is preferred to use pigments (for example, see Ganryo Bunsan Anteika to Hyomen Shori Gijutsu Hyoka (Pigment Dispersion Stabilization and Techniques of Surface Treatment Evaluation), First Edition, published by Gijutsu Joho Kyokai (Dec. 25, 2001) (hereinafter also referred to as non-patent literature 1). By changing coloring materials, inks of four colors of yellow, magenta, cyan and black can be formed. In particular, by using the pigments for use as offset printing inks and proofs, the same tone as the offset prints can be obtained and preferred.

As pigments for yellow inks, monoazo pigments, e.g., C.I. Pigment Yellow 1, and C.I. Pigment Yellow 74, disazo pigments, e.g., C.I. Pigment Yellow 12 and C.I. Pigment Yellow 17, non-benzidine series azo pigments, e.g., C.I. Pigment Yellow 180, azo lake pigments, e.g., C.I. Pigment Yellow 100, condensed azo pigments, e.g., C.I. Pigment Yellow 95, acid dye lake pigments, e.g., C.I. Pigment Yellow 115, basic dye lake pigments, e.g., C.I. Pigment Yellow 18, anthraquinone pigments, e.g., flavanthrone yellow, isoindolinone pigments, e.g., Isoindolinone Yellow 3RLT and C.I. Pigment Yellow 139, quinophthalone pigments, e.g., quinophthalone yellow, isoindoline pigments, e.g., isoindoline yellow, nitroso pigments, e.g., C.I. Pigment Yellow 153, and metal complex salt azomethine pigments, e.g., C.I. Pigment Yellow 117 are exemplified.

As pigments for magenta inks, monoazo pigments, e.g., C.I. Pigment Red 3, disazo pigments, e.g., C.I. Pigment Red 38, azo lake pigments:, e.g., C.I. Pigment Red 53:1 and C.I. Pigment Red 57:1, condensed azo pigments, e.g., C.I. Pigment Red 144, acid dye lake pigments, e.g., C.I. Pigment Red 174, basic dye lake pigments, e.g., C.I. Pigment Red 81, anthraquinone pigments, e.g., C.I. Pigment Red 177, thioindigo pigments, e.g., C.I. Pigment Red 88, perinone pigments, e.g., C.I. Pigment Red 194, perylene pigments, e.g., C.I. Pigment Red 149, quinacridone pigments, e.g., C.I. Pigment Red 122, isoindolinone pigments, e.g., C.I. Pigment Red 180, and Alizarin lake pigments, e.g., C.I. Pigment Red 83 are exemplified.

As pigments for cyan inks, disazo pigments, e.g., C.I. Pigment Blue 25, phthalocyanine pigments, e.g., C.I. Pigment Blue 15, acid dye lake pigments, e.g., C.I. Pigment Blue 24, basic dye lake pigments, e.g., C.I. Pigment Blue 1, anthraquinone pigments, e.g., C.I. Pigment Blue 60, and alkali blue pigments, e.g., C.I. Pigment Blue 18 are exemplified.

As pigments for black inks, organic pigments, e.g., aniline black pigments, and iron oxide pigments, and carbon black pigments, e.g., furnace black, lamp black, acetylene black and channel black are exemplified.

Further, processed pigments typified by Microlith Pigments, e.g., Microlith-A, -K and -T can also be preferably used. The specific examples thereof include Microlith Yellow 4G-A, Microlith Red BP-K, Microlith Blue 4G-T, and Microlith Black C-T.

Various kinds of pigments can be used according to necessity, e.g., as pigments for white inks, calcium carbonate and titanium oxide pigments, as pigments for silver inks, aluminum powders, and as pigments for golden inks, copper alloys are used.

It is preferred to use fundamentally one kind of pigment for one color from the point of the simplicity of manufacture of ink, but it is also preferred to use two or more pigments in combination in some cases for the purpose of adjusting the hue, such as the mixture of phthalocyanine with carbon black for black ink. Further, pigments may be subjected to surface treatment by well-known methods, e.g., rosin treatment, before use (the above non-patent literature 1).

The pigment content in all the ink composition is preferably from 0.1 to 50 mass %. The content of 0.1 mass % or more is sufficient as the pigment content and sufficiently good coloring can be obtained in the printed matters, and when the content is 50 mass % or less, particles containing coloring materials can be well dispersed in the dispersion medium. The pigment content is more preferably from 1 to 30 mass %.

Covering Material:

In the present invention, it is preferred that coloring materials such as pigments be dispersed (atomized) in a dispersion medium in the state of being covered with a covering material rather than to be directly dispersed (atomized). By covering with a covering material, the electric charge of-the coloring material is shaded and desired charge characteristics can be obtained. Further, the difference in dispersion stability between the kinds of coloring materials is nullified, and equal dispersion stability can be provided. Moreover, in the present invention, it is preferred that, after a recording medium (“a recording medium” means a medium on which an image is recorded, such as paper and the like) has been ink jet recorded, the medium be subjected to fixation with a heating means such as a heat roller, and at this time the covering material is melted by the heat and fixing is effected.

As the examples of covering materials, e.g., rosins, phenol resin, rosin-modified phenol resin, alkyd resin, (meth)acrylic polymer, polyurethane, polyester, polyether, polyamide, polyethylene, polybutadiene, polystyrene, polyvinyl acetate, an acetal-modified product of polyvinyl alcohol, and polycarbonate are exemplified. Of these covering materials, from the easiness of formation of particles, polymers having a weight average molecular weight of from 2,000 to 1,000,000, and the degree of polydispersion (weight average molecular weight/number average molecular weight) of from 1.0 to 5.0 are preferred. Further, from the easiness of fixation, polymers having any one of a softening point, glass transition point and melting point of from 40 to 120° C. are preferred.

The polymers particularly preferably used in the invention as the covering material are polymers containing at least any one of the constitutional units represented by the following formulae (1) to (4).

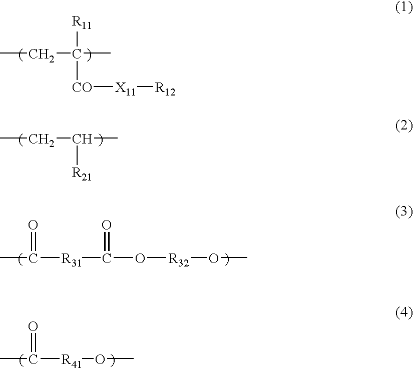

In the above formulae, X₁₁ represents an oxygen atom or-N(R₁₃)—; R₁₁ represents a hydrogen atom or a methyl group; R₁₂ represents a hydrocarbon group having from 1 to 30 carbon atoms; R₁₃ represents a hydrogen atom or a hydrocarbon group having from 1 to 30 carbon atoms; R₂₁ represents a hydrogen atom or a hydrocarbon group having from 1 to 20 carbon atoms; and R₃₁, R₃₂ and R₄₁ each represents a divalent hydrocarbon group having from 1 to 20 carbon atoms; and the hydrocarbon groups represented by R₁₂, R₂₁, R₃₁, R₃₂ and R₄₁ may have an ether bond, an amino group, a hydroxyl group or a halogen substituent.

A polymer containing a constitutional unit represented by formula (1) can be obtained by radical polymerization of a corresponding radical polymerizable monomer by known methods. As the radical polymerizable monomers to be used, (meth)acrylic esters, e.g., methyl(meth)acrylate, ethyl(meth)acrylate, propyl(meth)acrylate, butyl(meth)acrylate, hexyl(meth)acrylate, octyl(meth)acrylate, 2-ethylhexyl(meth)acrylate, dodecyl(meth)acrylate, stearyl(meth)acrylate, cyclohexyl(meth)acrylate, phenyl(meth)acrylate, benzyl(meth)acrylate, and 2-hydroxyethyl(meth)acrylate, and (meth)acrylamides, e.g., N-methyl(meth)acrylamide, N-propyl(meth)acrylamide, N-phenyl(meth)acrylamide, and N,N-dimethyl(meth)acrylamide are exemplified.

A polymer containing a constitutional unit represented by formula (2) can be obtained by radical polymerization of a corresponding radical polymerizable monomer by known methods. As the radical polymerizable monomer to be used, e.g., ethylene, propylene, butadiene, styrene and 4-methylstyrene are exemplified.

A polymer containing a constitutional unit represented by formula (3) can be obtained by the dehydration condensation of a corresponding dicarboxylic acid, or acid anhydride and diol by known methods. As the dicarboxylic acids to be used, succinic anhydride, adipic acid, sebacic acid, isophthalic acid, terephthalic acid, 1,4-phenylenediacetic acid and diglycolic acid are exemplified. As the diols to be used, ethylene glycol, 1,2-propanediol, 1,3-propanediol, 1,4-butanediol, 1,6-hexanediol, 1,10-decanediol, 2-butene-1,4-diol, 1,4-cyqlohexanediol, 1,4-cyclohexanedimethanol, 1, 4-benzenedimethanol, and diethylene glycol are exemplified.

A polymer containing a constitutional unit represented by formula (4) can be obtained by the dehydration condensation of a corresponding carboxylic acid having a hydroxyl group by known methods, or ring opening polymerization of a cyclic ester of a corresponding carboxylic acid having a hydroxyl group by known methods. As the carboxylic acids having a hydroxyl group or cyclic esters thereof to be used, 6-hydroxyhexanoic acid, 11-hydroxyundecanoic acid, hydroxybenzoic acid and ε-caprolactone are exemplified.

The polymers containing at least any one of the constitutional units represented by formulae (1) to (4) may be homopolymers of the constitutional units represented by formulae (1) to (4), or they may be copolymers with other constitutional units. These polymers may be used alone as the covering materials but two or more of these covering materials may be used in combination.

The covering material content in all the ink composition is preferably from 0.1 to 40 mass %. The content of 0.1 mass % or more is sufficient as the pigment content and sufficient fixation can be obtained, and when the content is 40 mass % or less, good particles containing a coloring material and a covering material can be formed.

Dispersant:

In the present invention, a coloring material, or the mixture of a coloring material and a covering material is dispersed (atomized) in a dispersion medium. For jetting ink droplets stably at all times during long term ink jet recording, a block polymer is used as a dispersant.

The block polymers in the invention are polymers having two or more polymer segments, and the block polymers are not particularly restricted so long as they can disperse a coloring material, but they are preferably polymers having a weight average molecular weight of 1,000 or more having two or more polymer segments having a weight average molecular weight of 500 or more. Block polymers particularly preferred as a dispersant are polymers containing at least a polymer segment insoluble in a dispersion medium and a polymer segment soluble in a dispersion medium. A block polymer represented by the following formula (5) is preferably used.
[A]-b-[B] (5)

In the above formula, A represents a polymer segment insoluble in a dispersion medium, and B represents a polymer segment soluble in a dispersion medium. b represents that Segment A and segment B are block bonded.

“A polymer segment insoluble in a dispersion medium” means that a polymer comprising the polymer segment alone is insoluble in a dispersion medium, specifically the solubility is preferably 3 g or less in a dispersion medium of 100 g (at 25° C.).

“A polymer segment soluble in a dispersion medium” means that a polymer comprising the polymer segment alone is soluble in a dispersion medium, and specifically the solubility is preferably 5 g or more in a dispersion medium of 100 g.

A block polymer containing a polymer segment insoluble in a dispersion medium and a polymer segment soluble in a dispersion medium becomes from the state of transparent to white turbid in a dispersion medium, and dissolved or dispersed. When such a block polymer is used, the main chains of the polymer segment insoluble in a dispersion medium are strongly adsorbed onto charged particles, as a result the retentive property of charged particles of the block polymer is improved, on the other hand, when the polymer segment soluble in a dispersion medium is dissolved in a dispersion medium, the affinity of the block polymer with the dispersion medium increases, as a result the dispersibility of the charged particles in a dispersion medium is improved.

The block polymers preferably used in the invention are polymers containing a polymer segment at least containing a constitutional unit represented by the following formula (6) and a polymer segment at least containing a constitutional unit represented by the following formula (7) and having a weight average molecular weight of 1,000 or more.

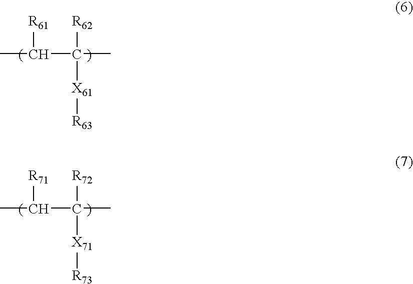

In formulae (6) and (7), R₆₁, R₆₂, R₇₁ and R₇₂, which may be the same or different, each represents a hydrogen atom or a methyl group.

R₆₃ represents a hydrogen atom or a hydrocarbon group having from 1 to 20 carbon atoms which may have a substituent, e.g., a silicon atom, an ether bond, an ester bond, an amido bond, a carbamate bond, a halogen group, a hydroxyl group, an amino group, an ammonium group, a carboxyl group, a sulfonic acid group, a phosphoric acid group, or a phosphonic acid group may be contained in the hydrocarbon group.

R₇₃ represents a hydrocarbon group having from 2 to 40 carbon atoms which may have a substituent e.g., a silicon atom, an ether bond, an ester bond, an amido bond, a carbamate bond, or a halogen group may be contained in the hydrocarbon group. It is preferred that the total carbon atom number of R₇₃ is more than the total carbon atom number of R₆₃ from the viewpoint of the ink jet stability.

X₆₁ and X₇₁, which may be the same or different, each represents a single bond, or a divalent linking group having total carbon atoms of 50 or less comprising two or more atoms selected from C, H, N, O, S and P.

The block polymer preferably used in the invention containing a polymer segment at least containing a constitutional unit represented by formula (6) and a polymer segment at least containing a constitutional unit represented by formula (7) can be obtained by radical polymerizing a radical polymerizable monomer corresponding to formula (6) and a radical polymerizable monomer corresponding to formula (7) using a radical polymerization initiator according to well known living radical polymerization methods. As the living radical polymerization methods, an Inifata polymerization method, an NMP method (Nitroxide-Mediated Polymerization), an ATRP method (Atom Transfer Radical Polymerization) and an RAFT method (Reversible Addition-Fragmentation Chain Transfer) are exemplified.

A monomer corresponding to formula (6) is a monomer represented by the following formula (6M), and a monomer corresponding to formula (7) is a monomer represented by the following formula (7M).

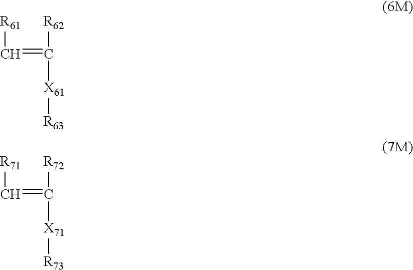

Each symbol in formulae (6M) and (7M) is the same as each symbol in formulae (6) and (7).

As the monomers represented by formula (6M), (meth)acrylic esters, e.g., methyl(meth)acrylate, ethyl(meth)acrylate, propyl(meth)acrylate, butyl(meth)acrylate, hexyl(meth)acrylate, octyl(meth)acrylate, 2-ethylhexyl(meth)acrylate, cyclohexyl(meth)acrylate, dodecyl(meth)acrylate, stearyl(meth)acrylate, phenyl(meth)acrylate, benzyl(meth)acrylate, 2-hydroxyethyl(meth)acrylate, and tetrahydrofurfuryl(meth)acrylate; (meth)acrylamides, e.g., N-methyl(meth)acrylamide, N-propyl(meth)acrylamide, N-phenyl(meth)acrylamide, and N,N-dimethyl(meth)acrylamide; (meth)acrylic acid, 2-(2-carboxyethyl)carbonyloxyethyl(meth)acrylate, 2-acrylamido-2-methylpropanesulfonic acid, 2-methacryloyloxyethylphosphoric acid; styrenes, e.g., styrene, methylstyrene, chlorostyrene, methoxystyrene, and carboxystyrene; hydrocarbons, e.g., 1-butene; vinylacetates; vinyl ethers; and vinylpyridines are exemplified.

As the monomers represented by formula (7M), (meth)acrylic esters, e.g., butyl(meth)acrylate, pentyl(meth)acrylate, hexyl(meth)acrylate, octyl(meth)acrylate, 2-ethylhexyl(meth)acrylate, cyclohexyl(meth)acrylate, dodecyl(meth)acrylate, stearyl(meth)acrylate, phenyl(meth)acrylate, benzyl(meth)acrylate, adamantyl(meth)acrylate, and 2-(perfluorobutyl)ethyl(meth)acrylate; (meth)acrylamides, e.g., N-methyl(meth)acrylamide, N-propyl(meth)acrylamide, N-phenyl(meth)acrylamide, and N,N-dimethyl(meth)acrylamide; styrenes, e.g., styrene, methylstyrene, chlorostyrene, and methoxystyrene; hydrocarbons, e.g., 1-butene; vinylacetates; vinyl ethers; vinylpyridines; allyltrimethylsilane, (3-acryloyloxy)methyldimethoxysilane, and (meth)acryloyloxypropylmethylsiloxane are exemplified.

The block polymers for use in the invention may have the constitutional units represented by formulae (6) and (7) alone, or may contain other constitutional units. As the specific examples of the block copolymers preferably used in the invention, polymers represented by the following formulae (BZ-1) to (BZ-8) are exemplified.

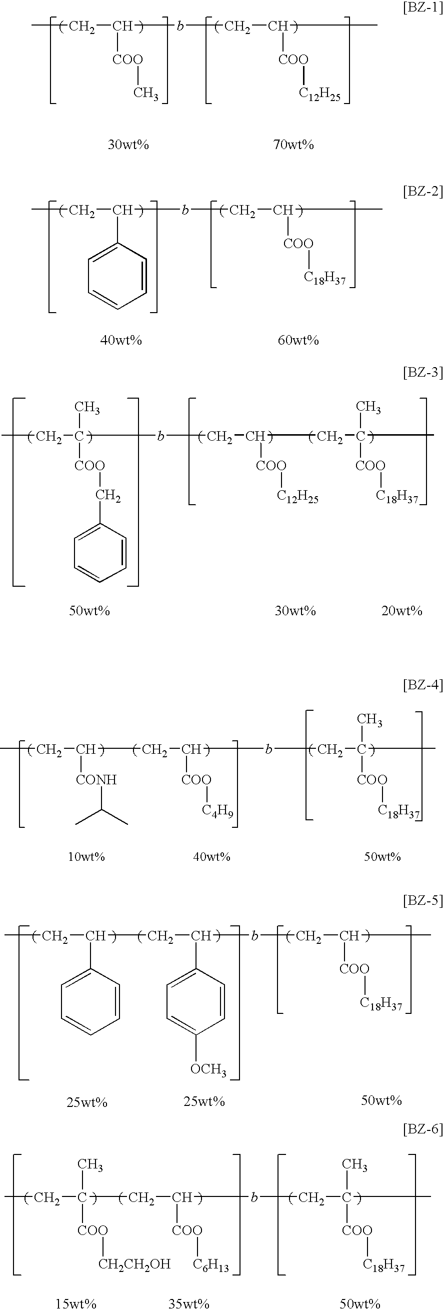

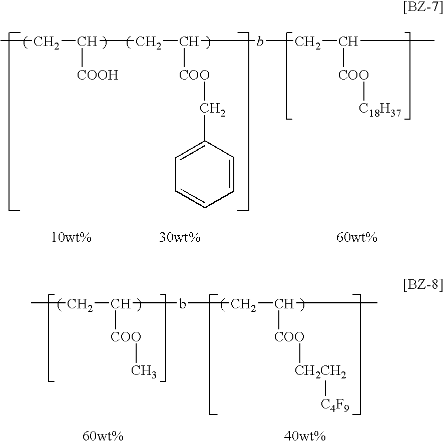

From the viewpoints of the long term storage stability of an ink composition and ink jet stability, it is preferred in the invention that block polymers have a weight average molecular weight of from 1,000 to 1,000,000, and the degree of polydispersion (weight average molecular weight/number average molecular weight) of from 1.0 to 7.0.

It is also preferred that the mass ratio of a polymer segment insoluble in a dispersion medium and a polymer segment soluble in a dispersion medium is from 5/95 to 90/10. These polymers as dispersants may be used alone or two or more of these polymers may be used in combination.

The addition amount of a dispersant in all the ink composition is preferably from 0.01 to 30 mass %. When the amount of a dispersant is in this range, ink particles do not cohere to jet heads and circulating pumps, so that clogging of the heads and pumps can be prevented, and a desired particle diameter can be obtained, as a result ink jetting at the time of ink jet recording becomes easy.

Electric Charge Adjustor:

In the invention, a coloring material (preferably the mixture of a coloring material and a covering material) is dispersed (atomized) in a dispersion medium with a dispersant, and it is preferred to use an electric charge adjustor in combination for controlling the charge quantity of particles.

As preferred electric charge adjustors, metal salt of organic carboxylic acid, e.g., zirconium naphthenate and zirconium octenoate, ammonium salt of organic carboxylic acid, e.g., tetramethylammonium stearate, metal salt of organic sulfonic acid, e.g., sodium dodecylbenzenesulfonate and magnesium dioctylsulfosuccinate, ammonium salts of organic sulfonic acid, e.g., tetrabutylammonium toluenesulfonate, a polymer having a carboxylic acid group at the side chain, e.g., a polymer having a carboxylic acid group obtained by modifying a copolymer of styrene and maleic anhydride with amine, etc., a polymer having a carboxylate anionic group at the side chain, e.g., a copolymer of stearyl methacrylate and tetramethyl-ammonium methacrylate, etc., a polymer having a nitrogen atom at the side chain, e.g., a copolymer of styrene and vinylpyridine, etc., and a polymer having an ammonium group at the side chain, e.g., a copolymer of butyl methacrylate and N-(2-methacryloyloxyethyl)-N,N,N-trimethylammoniumtosylate, etc., are exemplified. For maintaining electric charge for a long period of time, it is preferred in the invention to use electric charge adjustors of polymers. The electric charge given to particles may be positive charge or negative charge.

The amount of an electric charge adjustor in all the ink composition is preferably from 0.0001 to 10 mass %, and more preferably from 0.001 to 5 mass %. The quantity of charge of particles necessary for jetting is sufficed and appropriate in this range of the amount of an electric charge adjustor.

Other Components:

Further, antibacterial agents for preventing rottenness and surfactants for controlling the surface tension can be used in the invention, according to purpose.

Manufacture of Charged Particles:

An ink composition can be manufactured with these components, by dispersing (atomizing) a coloring material, preferably with a covering material, by using a dispersant of the invention. As the methods of dispersion (atomization), e.g., the following methods are exemplified.

1) After mixing a coloring material and a covering material in advance, the mixture is dispersed (atomized) with a dispersant and a dispersion medium, and an electric charge adjustor is added.

2) A coloring material, a covering material, a dispersant and a dispersion-medium are dispersed (atomized) simultaneously, and then an electric charge adjustor is added.

3) A coloring material, a covering material, a dispersant, an electric charge adjustor and a dispersion medium are dispersed (atomized) simultaneously.

Apparatus such as a kneader, a dissolver, a mixer, a high speed disperser, a sand mill, a roll mill, a ball mill, an attritor, and a beads mill are used in mixing and dispersing.

Physical Characteristic Values of Ink Component:

The thus manufactured ink composition is recorded on a recording medium by an ink jet recording system. For ensuring stable jetting of ink droplets at all times in long term ink jet recording, it is preferred in the invention to use an ink composition which satisfies any one or all of the following conditions.

(A) The volume average diameter of charged particles is in the range of from 0.20 to 5.0 μm.

(B) The concentration of the solids content of an ink composition is in the range of from 1 to 60 mass %.

(C) The electric conductivity of an ink composition at 20° C. is from 10 to 100,000 pS/cm.

(D) The viscosity of an ink composition at 20° C. is from 0.5 to 50 mPa.s.

The volume average diameter of charged particles can be measured by a centrifugal precipitation method with an apparatus, e.g., ultracentrifugal automatic particle size distribution measuring apparatus CAPA-700 (manufactured by HORIBA LTD.). There are a volume average diameter and a number average diameter in the average diameter of charged particles according to computing methods. In the invention, the volume average diameter of charged particles is preferably from 0.2 to 5.0 μm. When the volume average diameter is 0.2 μm or more, the concentration of particles is sufficient, as a result, blotting of inks can be prevented when recorded on a recording medium. When the average diameter is 5.0 μm or less, clogging of an ink composition at the spouts of head does not occur. The average diameter is more preferably from 0.3 to 3.0 μm. The particle size distribution is preferably narrower and more uniform.

In the invention, when the concentration of the solids content of an ink composition is from 1 to 60 mass %, the normalization of image density is effected and preferred.

The electric conductivity of an ink composition at 20° C. is preferably from 10 to 100,000 pS/cm. When the electric conductivity of an ink composition is 10 pS/cm or more, jetting of ink droplets is good, and when 100,000 pS/cm or less, ink smoothly passes through the heads (jetting parts) of ink jet apparatus and the heads are not damaged. More preferably the electric conductivity is from 50 to 50,000 pS/cm.

It is also preferred in the invention that the electric conductivity of ink particles is 30% or more of the electric conductivity of the ink-composition. In an ink jet recording system utilizing-electrostatic field, charged particles are concentrated when ink droplets are jetted, but when the electric conductivity of the particles is 30% or more, the charged particles are not concentrated, so that blotting of the ink does not occur when recorded on a recording medium. The electric conductivity is more preferably 50% or more. The electric conductivity of particles is a value obtained by centrifugally precipitating an ink composition, measuring the electric conductivity of the supernatant after the particles are precipitated, and subtracting the measured value of the supernatant from the electric conductivity of the ink composition.

The viscosity of an ink composition is preferably from 0.5 to 50 mPa.s in the invention. When the viscosity is 0.5 mPa.s or more, a problem of dripping of ink droplets from the ink jet spouts does not occur, and when it is 50 mPa.s or less, jetting of ink droplets is good. The viscosity is more preferably from 0.7 to 40 mPa.s.

The surface tension of an ink composition is preferably from 10 to 70 mN/m. When the surface tension is 10 mN/m or more, a problem of dripping of ink droplets from the ink jet spouts does not occur, and when the surface tension is 70 mN/m or less, jetting of ink droplets is good. The surface tension of an ink composition is more preferably from 15 to 50 mN/m.

Ink Jet Recording Apparatus:

The above ink composition is recorded on a recording medium by an ink jet recording system, and an ink jet recording system utilizing electrostatic field is preferably used in the invention. An ink jet recording system utilizing electrostatic field is a system of applying voltage between a control electrode and a back electrode in rear of a recording medium to whereby concentrate the charged particles of an ink composition at the jetting position by the electrostatic force, and jetting the ink composition from the jetting position to the recording medium. The voltage applied between a control electrode and a back electrode is, e.g., the control electrode is positive and the back electrode is negative when the charged particles are positively charged. The same effect can be obtained by charging a recording medium in place of applying voltage to a back electrode.

As an ink jet system, for example, a system of jetting ink from a needle-like tip such as an injection needle is known, and recording can be expedited by using the ink composition of the invention.

On the other hand, in a system wherein ink is circulated in an ink chamber having a jet opening, a control electrode is formed around the jet opening, an ink guide is present in the jet opening and the tip of the ink guide faces on the side of a recording medium, the concentrated ink droplets are jetted from the tip of the ink guide by the application-of voltage to the control electrode. Since the replenishment of charged particles by the circulation of the ink and the meniscus stability at the jetting position can be compatible, recording can be performed stably for a long period of time according to this system. Further in the system, since the exposure of the ink to the air is limited only to the jet opening, evaporation of the solvent is inhibited and physical characteristics of the ink are stabilized, so that the system can be very preferably used in the invention.

An example of the structure of an ink jet recording apparatus suitable to use the ink composition of the invention is described below.

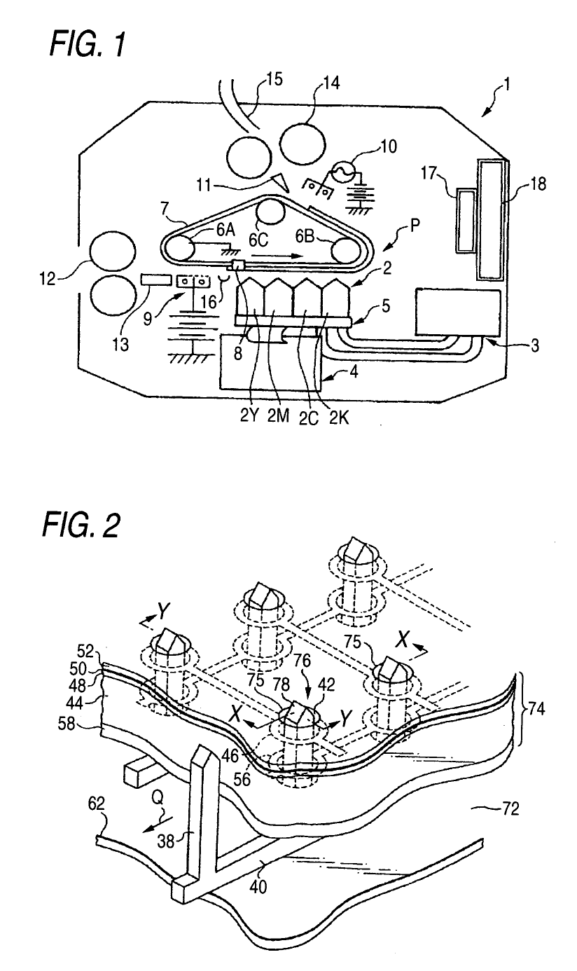

In the first place, the outline of the apparatus of performing four-color printing on one side of a recording medium shown in FIG. 1 is described.

Ink jet recording apparatus 1 shown in FIG. 1 is equipped with jet head 2 comprising jet heads 2C, 2M, 2Y and 2K of four colors for performing full color image formation, ink circulating system 3 for supplying and recovering inks to jet head 2, head driver 4 for driving jet head 2 by the output of the outside apparatus such as a computer and RIP not shown, and position controlling means 5. Ink jet recording apparatus 1 is further equipped with carrier belt 7 stretching on three rollers 6A, 6B and 6C, carrier belt position detecting means 8 consisting of an optical sensor and the like capable of detecting the position of carrier belt 7 in the width direction, electrostatic suction means 9 for maintaining recording medium P on carrier belt 7, and destaticizing means 10 and mechanical means 11 for peeling away recording medium P from carrier belt 7 after conclusion of image formation. Feed roller 12 and guide 13 for feeding recording medium P from a stocker not shown to carrier belt 7, and fixing means 14 and guide 15 for fixing the inks on recording medium P after being peeled and carrying the recording medium to a stocker of discharged paper not shown are arranged on the upstream and the downstream of carrier belt 7. In the inside of ink jet recording apparatus 1 are arranged recording medium position-detecting means 16 at the counter position to jet head 2 with carrier belt 7 between, exhaust fan 17 for recovering the vapor of the solvent occurring from the ink composition, and a solvent recovery part comprising solvent vapor adsorbing material 18, and the vapors in the inside of the apparatus are exhausted through the recovery part.

As feed roller 12, well-known rollers can be used, and feed roller 12 is arranged so that the feeding ability of recording medium P is increased. It is preferred to remove dirt and powder adhered on recording medium P. Recording medium P fed by feed roller 12 is carried to carrier belt 7 through guide 13. The back surface of carrier belt 7 (preferably a metal back surface) is provided via roller 6A. The recording medium carried is electrostatically adsorbed on the carrier belt by electrostatic suction means 9. In FIG. 1, electrostatic suction is performed by a Scorotron charger connected to negative high voltage power supply. The recording medium is electrostatically sucked on carrier belt 7 without floatation by electrostatic suction means 9 and, at the same time, the surface of the recording medium is uniformly charged. The electrostatic suction means is also utilized as a charging means of recording medium P here, but a charging means maybe provided separately. Charged recording medium P is carried to the jet head part by means of carrier belt 7, and electrostatic ink jet image formation is performed by piling recording signal voltage with charged potential as bias. Image-recorded recording medium P is destaticized by destaticizing means 10, peeled away from carrier belt 7 by mechanical means 11, and carried to the fixing part. Peeled recording medium P is carried to image fixing means 14 and fixed. The fixed recording medium P is discharged to a stocker of discharged paper not shown through guide 15. The ink jet recording apparatus is also equipped with a recovery means of the vapor of the solvent occurring from the ink composition. The recovery means comprises solvent vapor adsorbing material 18, the air containing the solvent vapor in the apparatus is introduced into the adsorbing material by exhaust fan 17, and the vapor is recovered by adsorption exhausted out of the apparatus. The ink jet recording apparatus is not limited to the above example, and the number, shape, and relative arrangement of constitutional devices, e.g., rollers and charger, and charge polarity can be arbitrarily selected. Four-color imaging is described in the above system, but the system may be a more multicolored system in combination with light-colored inks and special inks.

The ink jet recording apparatus used in ink jet printing method has jet head 2 and ink circulating system 3, and ink circulating system 3 further comprises an ink tank, an ink circulating tank, an ink concentration controlling apparatus and an ink temperature controlling apparatus, and the ink tank may contain a stirrer.

As jet head 2, a single channel head, a multi-channel head or a full line head can be used, and main scanning is performed by the rotation of carrier belt 7.

An ink jet head preferably used in the invention is a method to perform ink jetting by increasing the concentration of ink in the vicinity of the opening by the electrophoresis of charged particles in an ink channel. This method performs jetting of ink droplets by electrostatic suction force mainly originating in the recording medium or the counter electrodes arranged in the rear of the recording medium. Accordingly, even when the recording medium or the counter electrodes do not counter the head, or when voltage is not applied to the recording medium or the counter electrodes although they are positioned countering to the head, ink droplets are not jetted and the inside of the apparatus does not become dirty even if voltage is applied to the jet electrode or vibration is given by error.

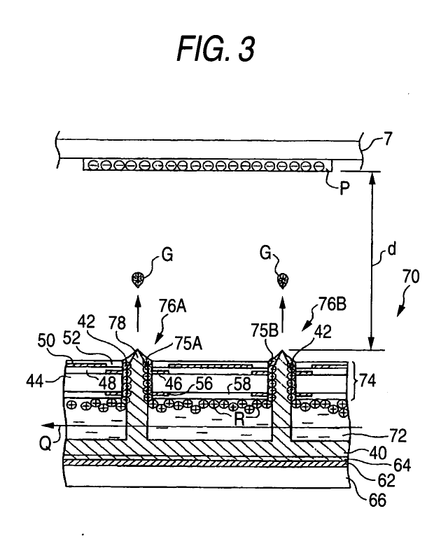

The jet head preferably used in the above ink jet apparatus is shown in FIGS. 2 and 3. As shown in FIGS. 2 and 3, ink jet head 70 has electrical insulating substrate 74 constituting the upper wall of ink channel 72 forming one way ink flow Q, and a plurality of jetting parts 76 jetting ink droplets toward recording medium P. Ink guide part 78 to guide ink droplets G flying from ink channel 72 to recording medium P is provided in each jetting part 76, openings 75 in each of which ink guide part 78 is built are formed on substrate 74, and ink meniscus 42 is formed between ink guide part 78 and the inner wall of opening 75. The gap d between ink guide part 78 and recording medium P is preferably from 200 to 1,000 μm or so. Ink guide part 78 is fixed on supporting bar 40 at the lower side.

Substrate 74 has insulating layer 44 electrically insulating two jet electrodes by separating at a prescribed space, first jet electrode 46 formed on the upper side of insulating layer 44, insulating layer 48 covering first jet electrode 46, guard electrode 50 formed on the upper side of insulating layer 48, and insulating layer 52 covering guard electrode 50. In addition, substrate 74 has second jet electrode 56 formed on the lower side of insulating layer 44, and insulating layer 58 covering second jet electrode 56. Guard electrode 50 is provided to prevent the electric fields of the contiguous jetting parts from being influenced by the voltage applied to first jet electrode 46 and second jet electrode 56.

Ink jet head 70 comprises floating conductive plate 62 in an electrically floating state. Floating conductive plate 62 constitutes the bottom of ink channel 72 and, at the same time, migrates upward (i.e., toward the side of a recording medium) ink particles (charged particles) R in ink channel 72 positively charged by induced voltage steadily generating by the pulse-like jet voltage applied to first jet electrode 46 and second jet electrode 56. Further, insulating covering film 64 is formed on the surface of floating conductive plate 62 to whereby prevent the physical properties and composition of ink from becoming labile by the application of electric charge to the ink, etc. The electric resistance of the electrical insulating covering film is preferably 10¹²Ω·cm or more, more preferably 10¹³Ω cm or more. It is preferred that the insulating covering film is anticorrosive to ink, by which floating conductive plate 62 is prevented from being corroded. Floating conductive plate 62 is covered with insulating member 66 from the down side. Floating conductive plate 62 is completely electrically insulated by this constitution.

Floating conductive plate 62 is present one or more per one head unit (for example, in the case where there are four heads of C, M; Y and K, each head has one floating conductive plate, and there is no case where C and M head units have a common floating conductive plate).

As shown in FIG. 3, for recording on recording medium P by jetting ink droplets from ink jet head 70, ink flow Q is generated by circulating the ink in ink channel 72, and prescribed voltage (e.g., +100 V) is applied to guard electrode 50. Further, positive voltage is applied to first jet electrode 46, second jet electrode 56 and recording medium P (when gap d is 500 μm, to form the potential difference of from 1 to 3.0 kV or so is a standard) so as to form jetting electric field among first jet electrode 46, second jet electrode 56 and recording medium P by which positively charged particles R in ink droplets G guided by ink guide part 78 and jetted from opening 75 are attracted to recording medium P.

When pulse voltage is applied to first jet electrode 46 and second jet electrode 56 in this state according to image signal, ink droplets G heightened in concentration of charged particles are jetted from opening 75 (for example, when the initial charged particle concentration is from 3 to 15%, the charged particle concentration of ink droplets G becomes 30% or more).

At that time, the value of voltage applied to first jet electrode 46 and second jet electrode 56 is in advance adjusted so that ink droplets G are jetted only when pulse voltage is applied to both first jet electrode 46 and second jet electrode 56.

Thus when positive pulse voltage is applied, ink droplets G are guided by ink guide part 78 and jetted from opening 75 and adhered to recording medium P, at the same time, positive induced voltage is generated in floating conductive plate 62 by positive voltage applied to first jet electrode 46 and second jet electrode 56. Even if the voltage applied to first jet electrode 46 and second jet electrode 56 is pulse voltage, the induced voltage is almost steady voltage. Accordingly, positively charged particles R in ink channel 72 get a force to be migrated upward by the electric field formed among floating conductive plate 62, guard electrode 50 and recording medium P, so that the concentration of charged particles R becomes high in the vicinity of substrate 74. As shown in FIG. 3, when many jetting parts (that is, channels for jetting inks) are used, many charged particles are necessary for jetting, but the number of first jet electrode 46 and second jet electrode 56 used increases, so that the induced voltage induced by floating conductive plate 62 becomes high, as a result the number of charged particles R migrating toward the recording medium also increases.

In the above, the example of positively charged colored particles is described, but the colored particles may be negatively charged. In that case, the above charge polarities are all inversed polarities.

In the present invention, it is preferred to fix inks by an appropriate heating means after ink jetting to the recording medium. As heating means, a contact type heating apparatus, e.g., a heat roller, a heat block and belt heating, and a non-contact type heating apparatus, e.g., a drier, an infrared lamp, a visible ray lamp, an ultraviolet lamp, and a hot air oven can be used. These heating apparatus are preferably linking and integrated with an ink jet recording apparatus. The temperature of a recording medium at fixing time is preferably from 40 to 200° C. for easiness of fixation. The fixing time is preferably from 1 μsec. to 20 sec.

Replenishment of Ink Composition:

In an ink jet recording system utilizing electrostatic field, the charged particles in an ink composition are jetted in a concentrated state. Accordingly, when ink jetting is performed for a long period of time, the charged particles in an ink composition are reduced and the electric conductivity of the ink composition lowers. Further, the proportion of the electric conductivity of the charged particles and the electric conductivity of the ink composition changes. In addition, since charged particles having greater particle sizes are liable to be jetted prior to charged particles having smaller particle sizes, the average diameter of charged particles becomes small. Further, the amount of solids content in the ink composition changes, so that the viscosity also changes. The fluctuation of the values of physical properties results in jetting failure, reduction of the optical density of recorded images and ink blotting. Therefore, by replenishing an ink composition having higher concentration (high in the solids content concentration) than the ink composition introduced in an ink tank at the beginning, the amount loss of the charged particles can be prevented, and the electric conductivity of the ink composition, and the proportion of the electric conductivity of the charged particles and the electric conductivity of the ink composition can be maintained in constant ranges. Further, the average particle size and the viscosity can also be maintained. Moreover, ink jetting can be performed for a long period of time stably by maintaining the values of physical properties of the ink composition in constant ranges. It is preferred to perform replenishment at this time mechanically or manually by computing the ullage from the detection of the values of physical properties such as electric conductivity and optical density of the ink solution in use. Replenishment may also be performed mechanically or manually by computing the amount of ink composition to be used on the basis of the image data.

Recording Medium:

In the invention, a variety of recording media can be used according to purposes. For example, by using papers, plastic films, metals, papers laminated or deposited with plastics or metals, and plastic films laminated or deposited with metals, directly printed products can be obtained by ink jet recording. The shapes of recording media maybe sheet-like planar shape or may be three-dimensional as cylindrical shape.

Fixation:

In the present invention, it is preferred to fix inks by an appropriate heating means after ink jetting to the recording medium. As heating means, a contact type heating apparatus, e.g., a heat roller, a heat block and belt heating, and a non-contact type heating apparatus, e.g., a drier, an infrared lamp, a visible ray lamp, an ultraviolet lamp, and a hot air oven can be used. These heating apparatus are preferably linking and integrated with an ink jet recording apparatus.

By using the ink composition in the invention as described above, jetting of ink droplets can be performed for a long period of time stably. Further, by using the ink jet recording apparatus described above, image recorded products having high image density and high quality free from ink blotting can be obtained for a long term. The main causes for these effects are not clear but it can be presumed that the particles using block polymers as dispersant do not agglomerate by shear stress and concentration generated in ink jetting at the inner wall of the head and the particles are present stably. The main causes are also due to the fact that the block polymers in the invention are high in adsorption onto a covering material and a coloring material, and the solubility in a dispersion medium is high. In addition, blocking can be prevented when image-recorded matters (printed matters) formed by ink jet recording and fixing are piled. The main cause of this effect is also not clear, but it is thought that the block polymers in the invention have high affinity with charged particles and low in the affinity with the back surface of a medium before image formation.

### EXAMPLE

The present invention is described in detail below with reference to examples, but the invention is not limited thereto.

### Example 1

Materials Used:

The following materials were used in Example 1.
Cyan pigment (a coloring material) : a phthalocyanine pigment, C.I. Pigment Blue (15:3) (LIONOL BLUE FG-7350, manufactured by Toyo Ink Mfg. Co., Ltd.)
Covering material (AP-1)
Block polymer dispersant (BZ-2) shown below
Electric charge adjustor (CT-1)
Dispersion medium, Isopar G (manufactured by Exxon)

The structures of covering material (AP-1), block polymer (BZ-2) and electric charge adjustor (CT-1) are shown below.

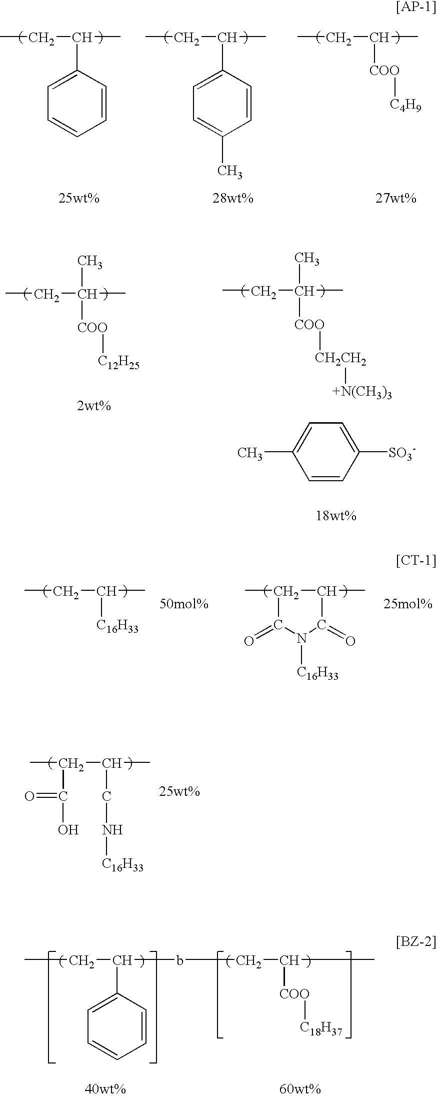

Covering material (AP-1) was obtained by radical polymerizing styrene, 4-methylstyrene, butyl acrylate, dodecyl methacrylate and 2-(N,N-dimethylamino)ethyl methacrylate with a well-known polymerization initiator, and further reacting with methyl tosylate.

(AP-1) has a weight average molecular weight of 15,000, the degree of polydispersion (weight average molecular weight/number average molecular weight) of 2.7, a glass transition point (a mid point) of 51° C., and a softening point of 46° C. by a strain gauge method.

Electric charge adjustor (CT-1) was obtained by reacting a copolymer of 1-octadecene and maleic anhydride with 1-hexadecylamine. (CT-1) has a weight average molecular weight of 17,000.

Synthesis of Block Polymer [BZ-2]:

A homopolymer of stearyl acrylate (HZ-1) was obtained by polymerization of stearyl acrylate under nitrogen atmosphere with methyl 2-bromopropionate, CuBr, and N,N,N′,N″,N″-pentamethylenediethylenetriamine as polymerization initiators. Since a polymer (HZ-1) has a bromo group at the terminal of main chain, polymerization is possible in the presence of CuBr and N,N,N′,N″,N″-pentamethylene-diethylenetriamine, further, block polymer (BZ-2) can be obtained by the polymerization with styrene. (BZ-2) has a weight average molecular weight of 57,000, a number average molecular weight of 45,000, and the degree of polydispersion (weight average molecular weight/number average molecular weight) of 1.27.

Homopolymer (HZ-1) dissolved in 100 g of Isopar G at 25° C. by 5 g or more. Block polymer dispersant (BZ-2) dissolved by 5 g or more in 100 g of Isopar G, although became white turbid.

Manufacture of Ink Composition [EC-1]:

Ten (10) grams of a cyan pigment and 20 g of covering material (AP-1) were put in a bench kneader PBV-0.1 (manufactured by Irie Shokai Co., Ltd.), and mixed with heating for 2 hours after setting the temperature of heater at 100° C. The obtained mixture (30 g) was coarsely pulverized in a Trio-Blender (manufactured by Trio Science Co., Ltd.), and further finely pulverized with an SK-M10 type sample mill (manufactured by Kyoritsu Rikoh Co., Ltd.). The obtained finely pulverized product (30 g) was preliminarily dispersed with 7.5 g of dispersant (BZ-2), 75 g of Isopar G and glass beads having a diameter of about 3.0 mm with a paint shaker (manufactured by Toyo Seiki Seisaku-Sho, Ltd.). After removing the glass beads, the preliminarily dispersed product was dispersed (atomized) with zirconia ceramic beads having a diameter of about 0.6 mm in Type KDL DYNO-MILL (manufactured by Shinmaru Enterprises Corporation) with maintaining the inner temperature at 25° C. for 5 hours, subsequently at 45° C. for 5 hours at an engine speed of 2,000 rpm. Zirconia ceramic beads were removed from the obtained dispersion, and 316 g of Isopar G and 0.6 g of electric charge adjustor (CT-1) were added thereto, whereby ink composition (EC-1) was obtained.

The physical properties of ink composition (EC-1) were as follows.

The electric conductivity of (EC-1) at 20° C. measured with an LCR meter (AG-4311, manufactured by Ando Electric Co., Ltd.) and electrodes for liquid (LP-05 type, manufactured by Kawaguchi Electric Works Co., Ltd.), and applied voltage of 5 V and frequency of 1 kHz was 800 pS/cm (80 nS/m).

The ink composition was subjected to centrifugal separation with a compact high speed cooling centrifuge (SRX-201, manufactured by TOMY SEIKO Co., Ltd.) at an engine speed of 14,500 rpm, at 20° C. for 30 minutes to precipitate the charged particles. The electric conductivity of the supernatant measured was 300 pS/cm (30 nS/m). The electric conductivity of the charged particles was 500 pS/cm (50 nS/m), which was 62.5% to the electric conductivityof the ink composition. The charge of the charged particles was positive.

The volume average particle diameter of the charged particles measured with CAPA-700 (manufactured by HORIBA LTD.) at an engine speed of 5,000 rpm was 1.0 μm. The number average particle diameter was 0.3 μm.

The viscosity of the ink composition at 20° C. measured with an E-type viscometer (manufactured by Tokyo Keiki Co., Ltd.) was 1.5 mPa.s. The surface tension of the ink composition at 20° C. measured with an FACE automatic surface tension meter (manufactured by KYOWA INTERFACE SCIENCE CO., LTD.) was 25 mN/m.

The solids content concentration of the ink composition was 9 mass %.

Ink Jet Recording:

Ink composition (EC-1) was filled in each of the ink tank linking with the head of the ink jet apparatus shown in FIGS. 1 to 3. As the jet head, 150 dpi (three-row zigzag layout of channel density of 50 dpi) of the type as shown in FIG. 2, 833 channel heads, and a silicone rubber heat roller having a built-in type 1 kW heater as the fixing means were used. As the temperature controlling means, an immersion heater and stirring blades were provided in the ink tank, ink temperature was set at 30° C., and the temperature was controlled with a thermostat with rotating the stirring blades at 30 rpm. The stirring blades were also used as a stirring means to prevent precipitation and agglomeration. The ink channel was made partly transparent, an LED luminescent element and a light detecting element were arranged with the ink channel between, and by the output signals, a dilution solution (Isopar G) and concentrated ink (the solids content of the above ink composition was concentrated three times) were put into the tank for controlling the concentration. As the recording medium, fine coat paper for offset printing was used. The dirt on the surface of the recording medium was removed by air pump suction, and then the jet heads were approached to the image-forming position of the recording medium, the image data to be recorded were transmitted to the arithmetic and control unit of image data, the jet heads were gradually moved with carrying the recording medium by the rotation of the carrier belt and jetting the ink composition, and an image was formed by 2,400 dpi imaging resolution. As the carrier belt, a metal belt laminated with a polyimide film was used. Line markers were arranged at one end of the belt along the carrying direction, and the markers were read optically by a carrier belt-detecting means, and by driving a position controlling means, an image was formed. At this time, the distance between the jet heads and the recording medium was maintained at 0.5 mm by the output of an optical gap detecting unit. The surface potential of the recording medium was set at −1.5 kV at jetting, pulse voltage of +500 V (pulse width of 50 μsec) was applied in performing jetting, and the image was formed at driving frequency of 15 kHz. Immediately after image recording, the image was fixed with a heat roller. The temperature of the coat paper at fixing time was 90° C. The contact time with the heat roller was 0.3 sec.

The obtained image-recorded matter (printed matter) was free from streaks and blotting of inks and an extremely clear image. Image-forming failure was not observed at all, image deterioration due to dot size fluctuation and the like did not occur even when the outside air temperature was changed and the recording time was increased, and good image formation was possible. After concluding recording, the ink jet recording apparatus was withdrawn by 50 mm from the position adjacent to the carrier belt for protecting the ink jet head. By cleaning the heads with supplying Isopar G in place of the inks for 10 minutes after the conclusion of recording, holding the heads in a cover filled with the vapor of Isopar G, good image recorded matters could be manufactured without necessitating maintenance work for 1 month. Further, 100 sheets of image recorded matters obtained were piled and stored at 40° C. for three days, but they did not adhere to each other.

### Comparative Example 1

Ink composition (RC-1) was manufactured according to the same manner as in the preparation of ink composition (EC-1) in Example 1 except that (HZ-1) obtained as the intermediate in the course of the synthesis of block polymer (BZ-2) was used in place of (BZ-2). The volume average diameter of the charged particles was 2.4 μm.

Ink jet recording was performed with the same apparatus as used in Example 1 and ink composition (RC-1), but ink droplets could not be jetted 2 weeks after. It was confirmed from the observation by disassembly that ink particles were adhered on the jet openings and clogged the jet openings. Further, when 100 sheets of image recorded matters obtained were piled and stored at 40° C. for three days, they adhered to each other.

### Comparative Example 2

Ink composition (RC-2) was manufactured according to the same manner as in the preparation of (EC-1) in Example 1 except that non-block polymer (HZ-2) (weight average molecular weight: 130,000) obtained by random polymerizing stearyl acrylate and styrene was used in place of block polymer dispersant (BZ-2). The volume average diameter of the charged particles was 2.7 μm.

Ink jet recording was performed with the same apparatus as used in Example 1 and ink composition (RC-2), but ink droplets could not be jetted 1 week after. It was confirmed from the observation by disassembly that ink particles were adhered on the jet openings and clogged the jet openings.

### Comparative Example 3

The manufacture of an ink composition was tried according to the same manner as in the preparation of (EC-1) in Example 1 except that homopolymer (HZ-3) (weight average molecular weight: 70,000) obtained by polymerizing styrene alone was used in place of block polymer dispersant (BZ-2), but particles could not be formed.

Polymer (HZ-3) was a polymer comprising the solvent-insoluble segment of block polymer dispersant (BZ-2) alone, and dissolved only by 3 g or less in 100 g of Isopar G.

### Example 2

Materials Used:

The following materials were used in Example 2.
Magenta pigment (a coloring material): a monoazo lake pigment, C.I. Pigment Red (57:1) (Symuler Brilliant Carmine 6B229, manufactured by Dainippon Ink and Chemicals Inc.)
Covering material (AP-2)
Block polymer dispersant (BZ-7) shown below
Tetrabutylammonium p-toluenesulfonate
Electric charge adjustor (CT-1)
Dispersion medium, Isopar G (manufactured by Exxon)

The structures of covering material (AP-2) and dispersant (BZ-7) are shown below.

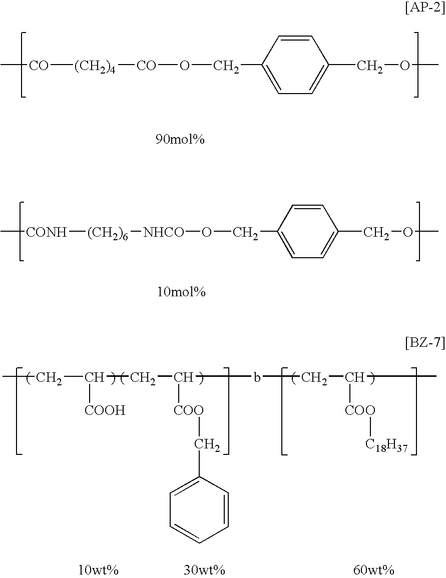

Covering material (AP-2) was obtained by the dehydration condensation of adipic acid and a little excess amount of p-xylylene glycol to whereby synthesize polyester having hydroxyl groups at both terminals, and further reacting the polyester with hexamethylene diisocyanate (AP-2) has a weight average molecular weight of 20,000, the degree of polydispersion (weight average molecular weight/number average molecular weight) of 1.6, a glass transition point (a midpoint) of −13° C., a melting point of 76° C., and a softening point of 74° C.

Synthesis of Block Polymer [BZ-7]:

Block polymer (BZ-7) was obtained by polymerizing stearyl acrylate polymer (HZ-1) having polymerization activity synthesized in Example 1, benzyl acrylate, and acrylic acid having a carboxyl group protected with tetrahydropyranyl ether, and further hydrolyzing to regenerate carboxylic acid. The weight average molecular weight of (BZ-7) was 90,000.

Manufacture of Ink Composition [EM-1]:

Ten (10) grams of a magenta pigment, 20 g of covering material (AP-2), and 1 g of tetrabutylammonium p-toluene-sulfonate were put in a flask, and stirred and mixed with heating by a heater for 1 hour so that the inner temperature became 110° C. The obtained mixture (31 g) was coarsely pulverized in a Trio-Blender (manufactured by Trio Science Co., Ltd.), and further finely pulverized with an SK-M10 type sample mill (manufactured by Kyoritsu Rikoh Co., Ltd.). The obtained finely pulverized product (31 g) was preliminarily dispersed with 9 g of dispersant (BZ-2), 75 g of Isopar G and glass beads having a diameter of about 3.0 mm with a paint shaker (manufactured by Toyo Seiki Seisaku-Sho, Ltd.). After removing the glass beads, the preliminarily dispersed product was dispersed (atomized) with zirconia ceramic beads having a diameter of about 0.6 mm in Type KDL DYNO-MILL (manufactured by Shinmaru Enterprises Corporation) with maintaining the inner temperature at 40° C. for 8 hours at an engine speed of 3,000 rpm. Zirconia ceramic beads were removed from the obtained dispersion, and 360 g of Isopar G and 0.4 g of electric charge adjustor (CT-1) were added thereto, whereby ink composition (EM-1) was obtained. The volume average diameter of the charged particles was 0.8 μm.

Ink Jet Recording:

Ink jet recording was performed with ink composition (EM-1) for 1 month in the same manner as in Example 1 by adding concentrated inks. A very clear image free from streaks and blotting of inks could be obtained without necessitating maintenance work.

### Comparative Example 4

Ink composition (RM-1) was manufactured according to the same manner as in the preparation of (EM-1) in Example 2 except that non-block polymer (HZ-4) (weight average molecular weight: 140,000) obtained by random polymerizing stearyl acrylate, benzyl acrylate and acrylic acid was used in place of block polymer dispersant (BZ-7). The volume average diameter of the charged particles was 2.5 μm.

Polymer (HZ-4) dissolved only by 3 g or less in 100 g of Isopar G.

Ink jet recording was performed with the same apparatus as used in Example 2 and ink composition (RM-1), but ink droplets could not be jetted 2 weeks after. It was confirmed from the observation by disassembly that ink particles were adhered on the jet openings and clogged the jet openings.

### Comparative Example 5

The manufacture of an ink composition was tried according to the same manner as in the preparation of (EM-1) in Example 2 except that non-block polymer (HZ-5) (weight average molecular weight: 90,000) obtained by polymerizing benzyl acrylate and acrylic acid was used in place of block polymer dispersant (BZ-7), but particles could not be formed.

Polymer (HZ-5) was a polymer comprising the solvent-insoluble segment of block polymer dispersant (BZ-7) alone, and dissolved only by 3 g or less in 100 g of Isopar G.

### Example 3

Materials Used:

The following materials were used in Example 3.
Yellow pigment (a coloring material): a disazo pigment, C.I. Pigment Yellow 180 (Toner Y HG, manufactured by Clariant Japan K.K.).
Covering material (AP-1)
Block polymer dispersant (BZ-8) shown below
Electric charge adjustor (CT-1)
Dispersion medium, Isopar G (manufactured by Exxon)

The structure of dispersant (BZ-8) is shown below. 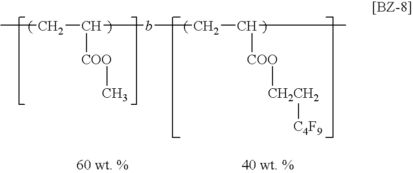
Synthesis of Block Polymer [BZ-8]:

Block polymer (BZ-8) was obtained by polymerizing methyl acrylate and 2-(perfluorobutyl)ethyl acrylate in the same manner as in Example 1.

The weight average molecular weight of (BZ-8) was 58,000. Block polymer dispersant (BZ-8) dissolved by 5 g or more in 100 g of Isopar G.

Manufacture of Ink Composition [EY-1]:

Eight (8) grams of a yellow pigment and 22 g of covering material (AP-1) were put in a bench kneader PBV-0.1 (manufactured by Irie Shokai Co., Ltd.), and mixed with heating for 2 hours after setting the temperature of heater at 100° C. The obtained mixture (30 g) was coarsely pulverized in a Trio-Blender (manufactured by Trio Science Co., Ltd.), and further finely pulverized with an SK-M10 type sample mill (manufactured by Kyoritsu Rikoh Co., Ltd.). The obtained finely pulverized product (30 g) was preliminarily dispersed with 7.5 g of dispersant (BZ-8), 75 g of Isopar G and glass beads having a diameter of about 3.0 mm with a paint shaker (manufactured by Toyo Seiki Seisaku-Sho, Ltd.). After removing the glass beads, the preliminarily dispersed product was dispersed (atomized) with zirconia ceramic beads having a diameter of about 0.6 mm in Type KDL DYNO-MILL (manufactured by Shinmaru Enterprises Corporation) with maintaining the inner temperature at 45° C. for 8 hours at an engine speed of 3, 000 rpm. Zirconia ceramic beads were removed from the obtained dispersion, and 316 g of Isopar G and 0.6 g of electric charge adjustor (CT-1) were added thereto, whereby ink composition (EY-1) was obtained. The volume average diameter of the charged particles was 1.1 μm.

Ink Jet Recording:

Ink jet recording was performed with ink composition (EY-1) for 1 month in the same manner as in Example 1 by adding concentrated inks. A very clear image free from streaks and blotting of inks could be obtained without necessitating maintenance work.

### Comparative Example 6

The manufacture of an ink composition was tried according to the same manner as in the preparation of (EY-1) in Example 3 except that homopolymer (HZ-6) (weight average molecular weight: 40,000) obtained by polymerizing 2-(perfluorobutyl)-ethyl acrylate was used in place of block polymer dispersant (BZ-8), but particles could not be formed. Homopolymer (HZ-6) was a polymer comprising the solvent-soluble segment of block polymer dispersant (BZ-8) alone, and dissolved by 5 g or more in 100 g of Isopar G.

### Comparative Example 7

The manufacture of an ink composition was tried according to the same manner as in the preparation of (EY-1) in Example 3 except that homopolymer (HZ-7) (weight average molecular weight: 63,000) obtained by polymerizing methyl acrylate was used in place of block polymer dispersant (BZ-8), but particles could not be formed. Homoolymer (HZ-7) was a polymer comprising the solvent-insoluble segment of block polymer dispersant (BZ-8) alone, and dissolved only by 3 g or less in 100 g of Isopar G.

### Comparative Example 8

Ink composition (RY-1) was manufactured according to the same manner as in the preparation of (EY-1) in Example 3 except that non-block polymer (HZ-8) (weight average molecular weight: 47,000) obtained by random polymerizing methyl acrylate and 2-(perfluorobutyl)ethyl acrylate was used in place of block polymer dispersant (BZ-8). The volume average diameter of the charged particles was 2.2 μm.

Polymer (HZ-8) dissolved by 5 g or more in 100 g of Isopar G.

Ink jet recording was performed with the same apparatus as used in Example 3 and ink composition (RY-1), but ink droplets could not be jetted 2 weeks after. It was confirmed from the observation by disassembly that ink particles were adhered on the jet openings and clogged the jet openings.

1. An ink composition for ink jet recording, comprising: a dispersion medium; and charged particles containing a coloring material, wherein the charged particles are dispersed in the dispersion medium by a dispersant containing a block polymer.

2. The ink composition for ink jet recording as claimed in claim 1, wherein the block polymer comprises a polymer segment insoluble in the dispersion medium and a polymer segment soluble in the dispersion medium.

3. The ink composition for ink jet recording as claimed in claim 1, wherein the dispersion medium is a dielectric liquid having a electrical resistivity of 10¹⁰ Ωcm or higher.

4. The ink composition for ink jet recording as claimed in claim 1, wherein the coloring material is dispersed in a dispersion medium in the state of being covered with a covering material.

5. The ink composition for ink jet recording as claimed in claim 1, wherein the block polymer is represented by the following formula (5):
[A]-b-[B] (5)
wherein A represents a polymer segment insoluble in a dispersion medium; B represents a polymer segment soluble in a dispersion medium; b shows that the Segment A and segment B are block-bonded.

6. The ink composition for ink jet recording as claimed in claim 1, wherein the block polymer is a polymer containing a polymer segment containing a constitutional unit represented by the following formula (6) and a polymer segment containing a constitutional unit represented by the following formula (7): 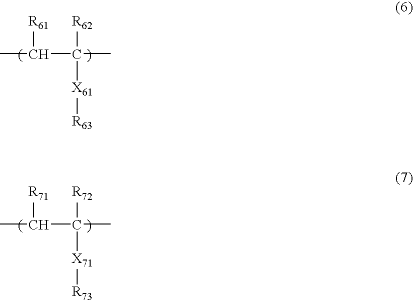
wherein R₆₁, R₆₂, R₇₁ and R₇₂, which may be the same or different, each represents a hydrogen atom or a methyl group;
R₆₃ represents a hydrogen atom or a hydrocarbon group having from 1 to 20 carbon atoms which may have a substituent, wherein a silicon atom, an ether bond, an ester bond, an amido bond, a carbamate bond, a halogen group, a hydroxyl group, an amino group, an ammonium group, a carboxyl group, a sulfonic acid group, a phosphoric acid group, or a phosphonic acid group may be contained in the hydrocarbon group;
R₇₃ represents a hydrocarbon group having from 2 to 40 carbon atoms which may have a substituent, wherein a silicon atom, an ether bond, an ester bond, an amido bond, a carbamate bond, or a halogen group may be contained in the hydrocarbon group;
X₆₁ and X₇₁, which may be the same or different, each represents a single bond, or a divalent linking group having total carbon atoms of 50 or less, which comprises two or more atoms selected from C, H, N, O, S and P.

7. The ink composition for ink jet recording as claimed in claim 1, wherein the block polymer has a weight average molecular weight of 1,000 or more.

8. The ink composition for ink jet recording as claimed in claim 1, which satisfies at least one of the following conditions:
(A) The volume average diameter of the charged particles is in the range of from 0.20 to 5.0 μm;
(B) The concentration of the solids content of the ink composition is in the range of from 1 to 60 mass %;
(C) The electric conductivity of the ink composition at 20° C. is from 10 to 100,000 pS/cm; and
(D) The viscosity of the ink composition at 20° C. is from 0.5 to 50 mPa.s.

9. A manufacturing method of an ink composition for ink jet recording, the ink composition comprising: a dispersion medium; and charged particles containing a coloring material, in which the method comprises dispersing the charged particles in the dispersion medium by a dispersant containing a block polymer.

10. An ink jet recording method comprising jetting an ink composition by utilizing electrostatic field, wherein the ink composition comprises a dispersion medium and charged particles containing a coloring material, and the charged particles are dispersed in the dispersion medium by a dispersant containing a block polymer.
